(19) United States
(12) Patent Application Publication
(10) Pub. No.: US 2007/0088751 A1
(43) Pub. Date: Apr. 19, 2007

(54) MULTIPARAMETER INDEXING AND SEARCHING FOR DOCUMENTS

(76) Inventors: Rudy DeFelice, Hermosa Beach, CA (US); Russell McGregor, Pasadena, CA (US)

Correspondence Address: FISH & RICHARDSON, PC, P.O. BOX 1022, MINNEAPOLIS, MN, 55440-1022, US

(21) Appl. No.: 11/564,577

(22) Filed: Nov. 29, 2006

Related U.S. Application Data
(62) Division of application No. 10/785,699, filed on Feb. 23, 2004.
(60) Provisional application No. 60/449,227, filed on Feb. 21, 2003.

(51) Int. Cl. G06F 17/00

(52) U.S. Cl. 707/104.1

(57) ABSTRACT

A multiparameter abstract and search system for documents, e.g. legal documents. The documents are abstracted by an abstract creation engine. The abstract creation engine may process the documents based on objective criteria and subjective criteria. The processing creates a searchable abstract file that can be searched in various ways.

### CROSS-REFERENCE TO RELATED PATENT APPLICATIONS

This application is a divisional of U.S. application Ser. No. 10/785,699, filed Feb. 23, 2004 which claims priority to U.S. Provisional Patent Application No. 60/449,227, filed on Feb. 21, 2003. The contents of these applications are incorporated by reference to the extent necessary for proper understanding of this disclosure.

### BACKGROUND

It is well-known to search through databases of documents using content-based, text searching. Many Internet-based search engines, such as Google™, enable content-based searching using proprietary searching techniques and algorithms. There are also several products focused on the legal space that employ content-based search techniques, including products with trade names such as Lexis™ and Westlaw™).

Another common technique for searching through data-bases of documents is to use content-based text searching in conjunction with pre-defined categories. Examples are document management systems, including those with trade names Documentum™, iManage™ or DocsOpen™. Those systems include databases with profile information about documents, which enable users to search for documents using a combination of category and text based searching. These existing systems, however, typically only include metadata about documents that is either (i) pre-set properties (such as who created the document based upon system login information) or (ii) information that is user-supplied.

### SUMMARY

The present technique teaches a multiparameter document categorization and search technique. According to aspects of this system, the information to be searched, herein called “documents”, are specially indexed using an abstract creation engine running on an abstract creation computer, that may employ a series of rules-based components to populate a database automatically with information about such documents. The engine categorizes documents according to both objective and subjective criteria according to a set of rules. The engine also employs content-based document abstracting, to enable searching through a combination of full-text, content-based information and detailed abstract information. This application also discloses project-based organization and retrieval of procedural information.

### BRIEF DESCRIPTION OF THE DRAWINGS

These and other aspects will now be described in detail with reference to the accompanying drawings, wherein:

FIG. 1 shows a block diagram of the abstract creation engine and computer;

FIG. 2 shows a diagram of the searching using the specially created abstracts in combination with content-based, text searching and incorporated workflow content; and

FIG. 3 shows a process flow for a specific rule set.

### DETAILED DESCRIPTION

The embodiment describes a document indexing and searching system. According to the present system, documents are analyzed according to a set of rules, and abstract files are created relating to contents and categories of such documents. The abstract files may be searchable files relating to contents of the documents. Searches can be carried out among the categorized documents. The search may therefore produce more pinpointed results. In an embodiment, the abstract files may be in markup language, e.g., XML, or Xtensable Markup Language, HTML, or any other markup language.

As described above, the term “document(s)” is used to refer to any source of information. The documents may be actual documents created by users, or published documents such as books, magazine articles, treatises, or publicly available information sources. In one aspect, the system is optimized for use by legal professionals, and therefore the documents may be legal documents, collections of statutes and rules, legal treatises, and other similar legal documents. However, the system is not limited to being used with legal documents, and in an alternative embodiment, the system is used to abstract documents which are not necessarily legal in nature.

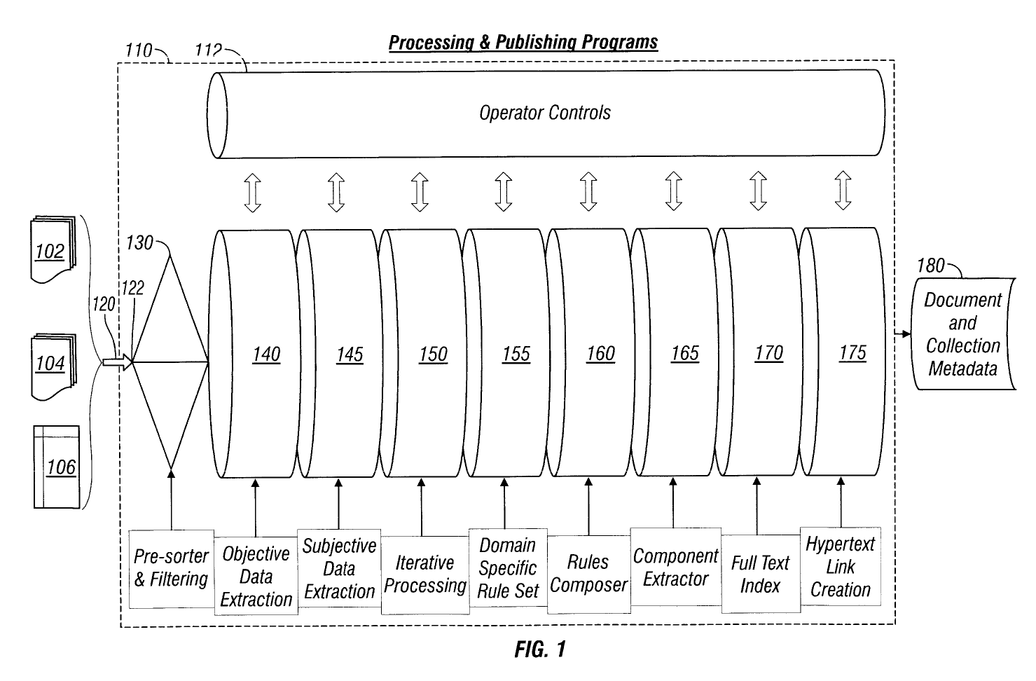

A block diagram of the basic document indexing system is shown in FIG. 1. Multiple types of documents, shown as 102, 104, 106, are input into the Abstract Creation Computer 110. The Abstract Creation computer 110 may include an operator interface with a number of operator controls shown as 112, and may automatically create abstracts of the input documents.

Initially, an input sorter shown as 120 collects the different kinds of documents, which documents can be in any of a number of different formats. The input sorter may include an interface to a scanner, and also a port for receiving other kinds of documents. The sorter may accept documents in multiple different formats, such as Microsoft Word documents, documents in XML or HTML, imaged documents (e.g., pdf, TIFF), or other formats. The input sorter investigates the format of the incoming information, and converts it to an acceptable format. For example, if the input format is in an image format, then the sorter 120 may optically character recognize certain text within the image, and create an XML document based on the optically recognized image. The converted document, available at 122, is input to the abstract creation components running within the abstract creation computer computer 110.

This abstract creation computer 110 may be formed in any kind of computer, preferably a server running Windows 2000 Server

The abstract creation components analyze the documents, categorize the documents, and publish information about the documents. An ‘abstract’ about each document is created in a searchable format. In an embodiment, the abstract is in XML format. The abstract is created in a memory module 120 that is associated with the computer 110.

A number of interconnected programs and program modules capture and interpret data about each document. The Components are discussed below in further detail.

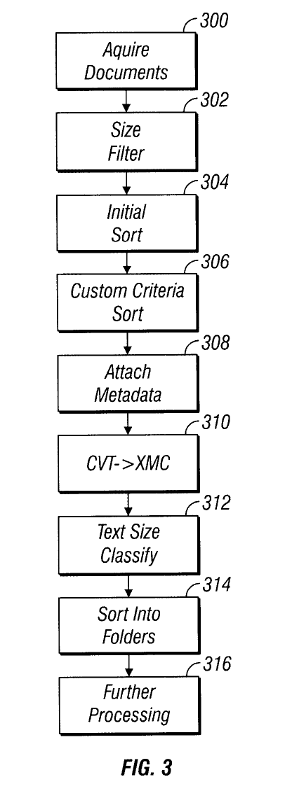

Prior to processing the documents, the presort module 130 may sort the documents into high-level categories depending on configurable criteria. The presorting may operate according the flowchart of FIG. 3. This module may also segregate documents into particular groups depending upon file size and number of characters based upon configurable criteria, or business rules Business rules is a generic term for domain-specific rule sets. For example, if a title includes the word “Complaint”, the document may be of type COMPLAINT. The system can then use these rules, in conjunction with rules to determine the document's legal type category. As an example, the rule can read IF FIND COMPLAINT, AND ALSO FIND ANSWER, THEN ANSWER OVERRULES) to categorize information.

At 300, the module acquires documents. As discussed above, this may include obtaining the document in either electronic or image form, from any source. At 302, the documents are filtered based on size. Any document less than a few lines could be assumed to have minimal useful information, for example.

The documents are then initially sorted, based on title or the like at 304. For example, in this embodiment, the documents can be initially sorted according to whether they relate to deals or other general categories (DealBank), to litigation (LitBank), or are letters/memos (MemoBank) Documents should be further sorted into document types, if known. In an embodiment, the high-level categories may include documents created by lawyers, local rules, state rules, federal rules, publicly available information sources, treatises and other publications, and other similar document categories. The user can select any one of these multiple categories.

The documents are then further filtered according to custom criteria at 306. File naming conventions and other metadata available in document management or file storage systems are evaluated to identify documents that might not be included in further processing. For example, documents might have a file name of ‘junk’ or ‘do not use’.

Known metadata about the document is saved to a file related to the document known as a Document Abstract Specification (“DAS”) file at 308. A query of an existing document management system, for example, can produce a report of the metadata that the system stores about the document. This information, such as title, author, and client matter number can be associated with the document through its DAS file.

This is followed by the documents being converted to a common format, e.g., XML or text form, at 310. The system may alternatively convert the documents to one or more of HTML, DOC, XML, or TXT. This allows the same tool to be used in the conversion of SmartRules and SmartRules Citations.

The documents are again filtered at 312 to create classes of documents that are based on the total amount of text. Some documents may pass the minimum file size threshold at 302 due to objects such as charts, logos, and grapes within the file. Nevertheless, these files may not contain sufficient useful text to be used as part of the system. For example a letter with a logo in the header could say simply “Attached please find a copy of your Employment Agreement.” Such a document might not be desirable in a searchable document collection, and may be segregated by this component depending upon configuration settings. 312 may be optional, and an alternative could use the original size filter at 302 by checking the character count on the Properties Sheet within the file itself, to determine file size threshold.

The documents are sorted into folders at 314. For example if two folders of agreements that have been converted are to be merged, the ‘txt’ and ‘junk’ subfolders should be merged below the newly created folder. Finally, the documents are submitted for further processing at 316. Folders that have been converted and cleaned may optionally be submitted to the creation computer recursively. For example the tool can be instructed to process a folder called ‘Deal’ and to process all of its sub directories.

As described above, the documents are processed to recognize and extract both objective data and subjective data. 140 represents the objective data extraction engine. This may be based on both system wide categories and also on user selected categories. For example, for a lawyer-created document, objective information may include lawyers listed on the document, a court of filing, and other information which can be determined from the document.

Lists of different allowable categories may be maintained to determine this information. For example, in order to determine the “lawyer” associated with a document, a list of possible lawyers could be maintained. Objective data abstractor 140 compares the contents of the document with all the possible lawyer names. If any of those lawyer names are found, then the document is categorized with that lawyer name. This avoids obtaining names that are not actually lawyer names, such as plaintiff/defendant names, typists' names, and the like. Alternate ways of determining lawyer names may look for certain lawyer-indicating terms, such as “Esq”, or “LLP”, and add the names with a specified relationship to those terms to the database of lawyer names used in the searching.

Similarly, objective data abstractor 140 may maintain a list of all possible court names. The user can select other categories and add or remove names as necessary. This may be used to determine the court name within the document.

More generally, the objective data abstractor determines “objective” information from the document, that is, a specific type of information such as a specified type of name. The objective data abstractor also rejects other information based on context within the document.

The subjective data abstractor 145 includes software that recognizes, analyzes and extracts subjective data from the file, again based on input characteristics and business rules. Subjective data may include information such as a legal task associated with the document; e.g., is it a complaint; a motion for a preliminary injunction; a patent application; or the like. This is done using rules that analyze the content and layout of a document based on specified criteria. For example, a document maybe categorized as a complaint based on its layout and contents. This is interpreted by a component that applies a series of rules to interpret the layout and contents of the document, and identify the applicable categories that apply to the document.

Another category of subjective information may be the document's objective, i.e., what is the document designed to achieve, or other subtype classification. Again, as above, this is defined in terms of rules which query document characteristics to determine the document's objective or subtype. One objective item may be whether a specific point of law is being urged. Another item of objective information may be substantive principles that are addressed in the document.

More generally, therefore, the subjective abstracter determines information categories within the document, rather than specific information of a specified type.

Module 150 refers to the iterative processing unit which is a series of software instructions that analyze documents and compare data extracted from a document to known values in a database, in order to draw conclusions about the document being processed. For example, the document may be associated with a group of other documents, and information about those other documents may be known. Additional data about such document may thus be derived based on the data relating to other documents in the database. The system can automatically reprocess the documents that have already been processed, if specified required data fields have not been extracted. For example, additional information about documents obtained after the document has been processed may enable a previously-unidentifiable category to be determined. The reprocessing mechanism typically will not change any assigned category. If the document has not initially been categorized with a document type, then the document may later be re-categorized when it is determined that the document looks like a complaint, based upon what the system has concluded about other documents that were complaints. Analogously, once an attempt to extract all of the objective and subjective data has been made, the iterative processor re-processes the once-categorized document, to see if these additional rules enable improved interpretation of the data.

155 represents a domain specific ruleset, which may be used to provide rules which are specific to a particular application of the Abstract Creation Computer (e.g., the legal industry as one example). A rules composer 160 may allow the user to create, view or modify rules for interpreting the data points that have been extracted or analyzed by the system.

165 represents a component extractor, that segregates the documents into distinct sub-parts according to a configurable rule set. For example, this may parse a document into its individual clauses, which are separately saved to the database. Multiple sets and subsets may be created for each application.

170 relates to a full-text indexer, which indexes the documents to allow content-based, full text searching. This may use any existing tool known in the art.

175 creates hypertext links within the documents. This may include a rule set that recognizes internal references to various data according to specified formats and automatically generates hypertext or other links to data that resides inside or outside the system. For example, this may recognize cites to various statutes, and create a link to either an Internet site hosting the statute, or to a document which includes the statute rules within the database.

The operator controls 112 may enable the operator to create, modify or view business rules, and adjust rules and thresholds. The operator can also view the processing results and edit them, publish and take other actions in accordance with the system and permissions, set and adjust privileges and permissions for users on the system, as well as monitor usage and create and manage the user groups.

The preferred output from the system is in XML format. The XML abstracts may include merged results from all the extractions, as well as metadata that has been created from the extractions. The XML abstracts are stored in storage 180 along with the original and converted versions of the document.

An important feature of this system is the ability to create a detailed abstract file about each document in a database. In use, the system might be used within a law firm, and applied to documents within the law firm's database. The Abstract Creation Computer 110 creates this abstract file (Document Abstract Specification file, which is formed of known metadata extracted from the file properties, the document management or file store, and metadata generated by its own component processing. This metadata information can then be searched. These categories may include Tasks to which document relates (generally, a document's high-level “Type”, the objective of the document, authors, parties, substantive areas, legal topics and concepts, jurisdiction, court, judge, dates, governing law, contents of clause titles or body, unique identifier in document storage systems, associated client numbers, as well as content-based full-text.

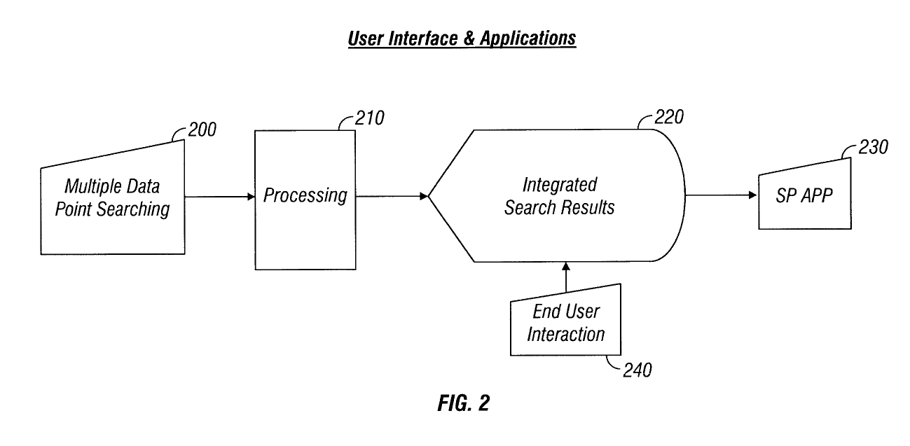

The categorized documents can be searched according to the searching engine shown in FIG. 2. Importantly, the system uses a multiple data point searching tool, shown as 200. The users can search according to any criteria or combination of criteria that has been discussed and extracted, stored or generated according to any of the Abstract Creation Components 100 notes above. The user interface may allow the user to select one or many of these documents, based on one or many criteria.

Once the search characteristics are selected, 210 enables processing the search criteria by interpreting the criteria and conducting numerous searches across the multiple databases for relevant results. This component searches for documents matching search criteria, and may incorporate in search results other information that may be related to the user's likely task, including project-based procedural guides.

The processing obtains not only the exact results as requested, called herein ‘explicitly requested results’, but also uses its own internal rule set to obtain documents which may be relevant according to the rules even if not explicitly requested. One aspect of the internal rule set is a built-in legal thesaurus, which automatically searches for synonyms for a specified word in its context. The rule set-determined-results may use domain specific taxonomies that are based on project related concepts, for example document type and objective.

The results are displayed on a user interface 220 which shows viewing, sorting and manipulating search results. This interface integrates the results of the searches across the various databases. According to an aspect of this user interface, the search results are created and displayed in a way that allows a user to peer within parts of the document. For example, the search results may be displayed showing an abstract of the document, including the reasons why the processing engine 210 determined that the document was relevant. This tool is labeled the ‘document abstract tool’, and enables the users to obtain increasingly detailed descriptions of the search results prior to opening the individual result. The initial part enables viewing information about the document, example title, jurisdiction, parties, other relevant information. Clicking on the document brings up a window showing other relevant information about the document, for example substantive legal areas, (example trademark, copyright) with each substantive legal area allowing a drill down to create more information about that legal area.

For example, clicking on TRADEMARK may bring up the different sub categories within trademark which are discussed, such as dilution, or registration.

Another aspect of this system includes a special-purpose application 230. One such special-purpose application is the Smart Rules application which is a tool that organizes, compiles and presents legal research in a project specific approach. This goes against the usual technique of organizing the information by source, in favor of a new technique that favors organization according to its relevance to a users' anticipated project.

For example, a user may specify a specific type of legal activity or document, and in return receive rules, codes, laws and editorial information that would be relevant to that type of document or project, regardless of the original source of that material, in a single search. The search results may also include narrative information about the rules, codes and laws, as well as hypertext links to the specific sources either inside or outside the database system.

The management and publishing of the SmartRules system may be facilitated by the Abstract Creation Engine running on the Abstract Creation Computer. The Abstract Creation Engine may create hypertext links in editorial content to link that content to information in other parts of the database or on the internet. This can be done manually by creating abstracts for each of a plurality of anticipated topics. Alternately, this may use the Abstract Creation Computer on each of a number of different sources of information to automatically create this information.

The user performs a single search describing the activity and the court, and this delivers relevant rule parts, and also checklists and other information. The SmartRules can be pre-compiled, for each of multiple documents, courts, and jurisdictions based on the Abstract Creation Engine.

Using an example of the SmartRules system, a user may input criteria indicating a project concerning a “Complaint” for the United States District Court for the Central District of California. The SmartRules system returns a collection of information including those things which are necessary to comply with procedural and court rules, as well as editorial content and practice information, in a single search. The returned information may include state rules and local rules referenced in the editorial content, links to underlying rules and statutes or other sources, and may include information from external sources such as treatises, about the subject. The returned information may also include court specific rules, judge specific rules, and state or federal regulations or rules and related information. This compares with existing search systems which are organized and used according to the source of information, not by user task.

The information which is returned is categorized. The categorized information includes categories such as timing of the complaint, specific rules about the complaint such as page limits, fonts and the like, form and format of the complaint, information about how to introduce things into evidence, and other such information related to that activity. Also, users may do a content-based search in SmartRules, so that a user may obtain all results that address a certain statute, or other text based criteria.

Each section may include links to the actual rules and statutes, so that the user can click on a link and view the actual rule and/or statute within a separate window.

Another special-purpose information that forms a part of the user interface 210 is a document component search tool, which searches for common documents components across the individual documents or files that is enabled by the components extractor 165. This enables users to search for individual sub-parts of documents or files, that have been identified in advance by the component extractor.

The end user interaction tool 240 allows the end-users to obtain more information about the search results, and also allows users to designate part or all of the search results for classification in user-defined classification systems called Folios.

As described above, extraction of each of a plurality of fields occurs according to rules that are written to extract the data from those fields. Certain rules and their functions are described herein in further detail, to illustrate the concepts. However, it should be understood that these rules merely illustrate the concepts of using rules; and that other rules may be and are used. In each of these examples, information about the document is found by looking for clues within the document, and extracting the information from the document itself. The determination of document types may cause execution of different rules and rule sets are used for the different high-level document types. For example, a document which is categorized as a litigation document may have title, counsel name, and parties extracted in a different way than a document that is classified as a deal document

Counsel (for a Deal Document)

For extraction of counsel, a database of counsel names may be maintained. This information may also be obtained from text-based indicators in the documents (such as term “LLP”, or obtained from document management system or storage systems.

```
{
  FOR EACH RULE IN THE RULES FILE REPEAT THE
  FOLLOWING: {
    FOR EVERY MATCH IN THE DOCUMENT DO  {
RETRIEVE THE STRING THAT MATCHED THE FIRST
SUB-EXPRESSION S1(;
RETRIEVE THE STRING THAT MATCHED SECOND
SUBEXPRESSION S2;
COUNSEL = S1 + S2;
STORE THE COUNSEL IN THE LIST AND CONTINUE WITH
NEXT MATCH;  }
```

Example with a copy to:
Shook, Hardy & Bacon L.L.P.

Rule:
with\s*a\s*copy\s*to\s*:(.*)(LLP|P\.{0,1}C\.{0,1}|L\.L\.P\. |P\.A\.)

In the example above, the regular expression matches this string. The first subexpression matched is Shook, Hardy & Bacon and the second sub-expression matched is L.L.P. Either one will allow a match. In this case, the regular expression has 2 subexpressions.

Note that the same or different rules can be used to extract counsel from a non-deal document. Since different documents look different, a rule may be specially written to deal with the different place that the information might be.

Date

The data rule operates as follows:

Extract first few lines in the document to limit the date search.

For each rule in the DateRules File, repeat the following steps until a match is found or rules are exhausted.

```
{
  IF MORE THAN ONE EXPRESSION MATCHES RETURN ERROR.
If a match is obtained, extract the date until
the string ending with 4-digit year using regular
expression.
  CLEANSE THE DATE EXTRACTED BY REMOVING LEADING
  AND TRAILING SPACES,
NEW LINES ETC. ELIMINATE UNWANTED WORDS AND
CHARACTERS FROM DATE STRING. }
```

e.g.: AGREEMENT AND PLAN OF MERGER (this “AGREEMENT”), dated as of Jan. 22, 2001, by and among Corning Incorporated, . . .

Matching Rule: (Dated\s*\n*as\s*\n*of\s*\n*\(the)?)

The above rule gets matched for the given example and the matched string will be “dated as of”, so that the date is after the string. To extract the date, another rule can be applied such that everything after the matched string until the four digit number, providing: “Jan. 22, 2001”.

```
  }
    IF NO MATCHES, NEXT RULE:
    FOR EACH RULE IN THE DATECLAUSE RULES FILE REPEAT
    THE FOLLOWING STEPS
UNTIL A MATCH IS FOUND OR RULES ARE EXHAUSTED.
  {
```

IF A MATCH IS OBTAINED, EXTRACT THE DATE UNTIL THE STRING ENDING WITH 4-DIGIT YEAR USING REGULAR EXPRESSION.

CLEANSE THE DATE EXTRACTED BY REMOVING LEADING AND TRAILING SPACES, NEW LINES ETC. ELIMINATE UNWANTED WORDS AND CHARACTERS FROM THE DATE STRING.

e.g.: PLAN EFFECTIVE DATE AND SHAREHOLDER APPROVAL. The Plan has been adopted by the Board effective Jan. 8, 1997, subject to approval by the . . .

Matching Rule:

```
(PLAN\s*\n*EFFECTIVE\s*\n*DATE\s*\n*AND\s*\
n*SHAREHOLDER\s*
\n*APPROVAL) (.*) effective\s
    HERE THE EXPRESSION MATCHES UNTIL “...BOARD
    EFFECTIVE” AND THEN THE
SAME DATE RULE WILL BE APPLIED AS IN THE ABOVE CASE
TO EXTRACT THE DATE PART.
  }
  }
```

Title

Title extraction may use multiple different rules. The basic approach is:

```
    {
    SKIP ALL EMPTY AND BLANK LINES.
    EXTRACT FIRST FEW LINES IN THE DOCUMENT TO LIMIT SEARCH.
    SKIP ANY TITLE HEADER IN THE DOCUMENT USING THE RULES DEFINED IN
TITLEHEADERLIST.TXT
    FOR EACH RULE IN THE TITLERULES FILE, REPEAT THE FOLLOWING STEPS UNTIL A
MATCH IS FOUND OR RULES ARE EXHAUSTED.
  {
    IF THERE WAS A MATCH EXTRACT THE MATCHED STRING.
    CLEANSE THE STRING AND CHECK FOR NOISE WORDS USING RULES DEFINED IN
TITLENOISEWORDS.TXT
    IF TITLE EXTRACTED MATCHED NOISE WORDS SKIP AND CONTINUE TO SEARCH.
    ELSE CLEANSE THE EXTRACTED STRING BY REMOVING UNWANTED NEW LINE AND
WHITE SPACES. }
```

e.g.: INCENTIVE COMPENSATION PLAN

1. Purpose. The purpose of this Incentive Compensation Plan (the “Plan”) is to assist Lincoln National Corporation, an Indiana corporation . . .

In the example above the first title rule matches “INCENTIVE COMPENSATION PLAN” which is all in caps.

Another rule can simply look for words in all CAPS in the beginning of the document.

DocType/SubType for Deal Bank documents, titles are extracted primarily through comparison of known titles to a doctype/subtype matrix.

This makes use of DocTypeRules.txt rules file. The format of the rules file is as follows:

```
  TITLE_RULE<TAB>TEXT_RULE<TAB>CHAR_COUNT<TAB>DOC_TYPE<TAB
>DOC_SUBTYPE
  TITLE_RULE will be empty if there is no title rule.
  Approach
  {
    FOR EACH ENTRY IN THE DOCTYPERULES FILE REPEAT THE FOLLOWING STEPS.
  {
  FIRST SEE IF TITLE RULE IS AVAILABLE, IF SO APPLY THE RULE ON THE TITLE EXTRACTED.
      IF SUCCEEDED GET THE CORROSPONDING DT/ST.
    IF THE DT/ST ARE ALREADY IN THE LIST SKIP IT ELSE SAVE THE DT/ST IN THE LIST.
    IF FAILED TO EXTRACT FROM THE TITLE RULE OR NO TITLE RULE WAS AVAILABLE
APPLY TEXT RULE ON FIRST N CHARS OF THE DOCUMENT.
    IF SUCCEEDED SAVE CORRO. DT/ST IF NOT ALREADY IN THE LIST.
    }
  }
```

Parties

Parties information can be found in the beginning of the document, in the signature block or/and in the title of the document itself. Each of these may use a different set of rules.

Approach:

```
{
  EXTRACT FIRST FEW LINES IN THE DOCUMENT.
  REMOVE ANY BLANK LINES.
FOR EACH RULE IN THE PARTYRULE FILE REPEAT THE FOLLOWING STEPS.
{
  IF A MATCH, EXTRACT THE MATCHED STRING
  IF THE EXTRACTED STRING IS SAME AS TITLE IGNORE THE STRING.
  IF THE MATCHED STRING HAS ANY NOISE WORDS SKIP IT.
  ELSE STORE THE PARTY IN THE LIST.
  REPEAT THIS RULE ON THE REST OF THE BUFFER FOR MORE PARTIES UNTIL THE END OF
THE BUFFER.
  }
    IF NO PARTIES EXTRACTED:
  {
    FROM THE TITLE STRING OF THE DOCUMENT EXTRACT EACH LINE
  AND CHECK FOR INC., CORPORATION, INCORPORATED, CORP, AND COMPANY.
IF FOUND, THAT LINE OF TEXT WILL BE TREATED AS THE PARTY.
  }
    IF NO PARTIES EXTRACTED IN ABOVE 2 STEPS
  {
    SEARCH FOR STRING “IN WITNESS WHEREOF” IN THE DOCUMENT
```

IF MATCH FOUND REPEAT THE FOLLOWING STEPS UNTIL ALL THE PARTIES HAVE BEEN EXTRACTED OR END OF FILE HAS BEEN REACHED:

```
    LOOK FOR BY OR BY_{—} OR BY:
    EXTRACT ALL THE LINES OF TEXT PRECEDING BY OR
    BY_{—} OR BY:
    LOOK FOR A LINE, IN ALL CAPS, THAT IS CLOSEST TO
    BY_{—} OR BY: OR BY WHICH
WILL BE TREATED AS ONE OF THE PARTIES AND ADDED TO
THE PARTY LIST.
  }
  }
    }
```

Governing Law.

For extraction of Governing Law, StateRules.txt is used, which includes rules related to Governing Law. Another file called StateList.txt is used for looking up all the State/Province Information.

```
{
    FOR EACH RULE IN THE RULES FILE REPEAT THE
    FOLLOWING STEPS:
    {
        RUN THE RULE ON THE DOCUMENT TEXT.
```

IF THE RULE MATCHED, EXTRACT THE STATE, IF ANY, FOLLOWING THE RULE MATCH. TAKE FOR INSTANCE “IN ACCORDANCE WITH THE LAWS OF THE STATE OF DELAWARE”. IN THIS CASE THE RULE WOULD MATCH THE PHRASE “IN ACCORDANCE WITH THE LAWS OF THE STATE OF”. SO WE'LL LOOK FOR THE STATE TO FOLLOW THIS.

```
  IF STATE IS FOUND BREAK OUT OF THE LOOP.
  }
}
```

As noted above, other rules, having analogous parameters, may be used.

Many of the rules given above were for Deal documents. Litigation documents may also have abstract fields. Due to the presence of a substantially consistent caption on the first page of litigation documents, different techniques may be used to capture the data.

Some DocTypes are dependent on other Doc Types. For example

eg: see document 0080002.01

NOTICE OF HEARING ON DEMURRERS AND DEMURRERS OF DEFENDANTS KAUFMAN AND BROAD HOME CORPORATION, KAUFMAN AND BROAD OF SOUTHERN CALIFORNIA, INC., AND KAUFMAN AND BROAD HOME SALES, INC. TO THE ALLEGED THIRD, SIXTH AND SEVENTH CAUSES OF ACTION OF THE COMPLAINT

(Memorandum of Points and Authorities In Support Thereof Attached Hereto; Motion To Strike Portions Of Complaint Filed Concurrently Herewith)

There are 4 matches here:

Notice

Demurrers

Memorandum of Points and Authorities

Motion To Strike

The Abstract Creation Engine uses rules to make subjective conclusions about document types. For example, if the rules uncovered terms “Answer” and “Complaint”, the rules can determine that the Document Type is an “Answer” only. This is achieved by the rules which consider the relationships between document types and pre-set desired outcomes for all conditions.

Demurrers and Notice are related/dependent.

Notice dominates Demurrers and its located before Demurrers

Also the presence of ‘to’ next to Notice helps.

Back tracking (AI technique)

General:

Given a document, first look for Abstract already in the Database.

Certain fields like Jurisdiction, Judge Name, Firm name will repeat.

Assumption:

One document will not have more than one Judge Name, or Case number.

There are instances of finding more then one Court names in one document. In those cases, heirarchy rules are applied.

As the table in the database fills, a continuously improving strike rate is obtained. However, at all times the search can be limited to the first page.

Case Number:

Case number is generally found next to Case No: Docket No etc. If a case number is easily found, then a lookup can be done in Existing published and queued documents to get known Abstract fields associated with that case, including:

Abstract field

DocType And Doc Title

DocType And Doc Title:

The Abstract Creation Engine uses the rules to make subjective conclusions about document types. For example, if the rules uncovered terms “Answer” and “Complaint”, then the rules determine that the Document Type is an “Answer” only. This is achieved by a list of relationships between document types and pre-set desired outcomes for all conditions.

Approach:

```
OPEN A DOCUMENT
LIMIT SEARCH TO FIRST OR SECOND PAGE (E.G., 52-60 LINES)
TRAVERSE THROUGH EACH POSSIBLE DOCTYPE LIST
  FIND THE DOCTYPE KEWORD/PHRASE IN THE FIRST PAGE
    IF FOUND
      GET THE SENTENCE IN WHICH THIS WORD OCCURS.
      THIS BECOMES THE DOCUMENT TITLE.
      IF THIS DOCTYPE IS DEPENDENT ON ANOTHER
      DOC TYPE
        GET THE ORDERING TO DETERMINE DOMINANT
        DOCTYPE
        VERIFY USING TRAITS (FOLLOWING WORD) TO GET
DOCTYPE
```

Firm/Counsel Name

Firm name is generally found at start of the document.

Firm name can be found followed by LLP or LLC. It can be found in Above or Below line of Lawyer Name. Lawyer Name may be followed by “Bar . . . No”.

Judge Name/Dept

Judge name may be found next to “Judge Name”, “Magistrate”, Dept:, Dept No:. It is generally found near to document “Title”.

State/Jurisdiction

Jurisdiction Processing Logic is done as a Four Step Process. Take an Jurisdiction Title as example.

In The District Court Of

Harris County, Tex.

281st Judicial District

The Jurisdiction Header can be extracted first. This should contain enough information to allow obtaining State Name, Court Type and Court Name. In the above example, this allows extracting “The District Court Of Harris County, Tex.”. This is done by the Stepped Jurisdiction Rules.

Each line in this Rules list corresponds to a Rule. Each Rule contains up to three Sub Rules separated by a tab. To extract the above string, one of the rules as “IN THE (DISTRICT|JUSTICE) COURT (ˆ\w*\s*){0,1}\w*\sCOUNTY,?\s*TEXAS \d*\w*\sJUDICIAL\s*DISTRICT” is found.

Incidentally, this Rule extracts all three lines of the above Jurisdiction Title, even though two lines would have been sufficient. The Sub Rule “IN THE (DISTRICT|JUSTICE) COURT” extracts “In The District Court”, while the Sub Rule “(ˆ\w*\s*){0,1}\w*\sCOUNTY,?\s*TEXAS” will extract “Harris County, Texas” and the Non-Mandatory Sub Rule “\d*\w*\sJUDICIAL\s*DISTRICT” will extract “281st Judicial District”.

Subsequent to the extraction, the above strings are concatenated and the Jurisdiction Header is thus constructed. This Header is then used for the further three steps.

Next, extract the Court Type from the Jurisdiction Header obtained above. This is done using the litCourtList Rules. The Court Type extracted in the above example is “DISTRICT”.

Third Step: All the Court Types are mapped to a default Court Type Mapping based on the California system. If the Court Type of any State differs from that of the default, then it is mapped to the default in the litCourtNameAlias Rules. In the above case, the “District” court in Texas is mapped to “Superior” court in California. One of the rules in this list is “TEXAS DISTRICT SUPERIOR (JUDICIAL|COUNTY)”. Herein there are four Sub Rules separated by a tab. The first Sub Rule identifies the state (“Texas” in this case), the second Sub Rule identifies the Name (“District”), the third gives the mapped Court Type (“Superior” herein), while the fourth Non-Mandatory Sub Rule provides the supporting string which helps in Positive identification. If there is either “JUDICIAL” or “COUNTY” in the Jurisdiction Header, that when this Court Type gets mapped to “Superior” Court, otherwise it will be a District Court of Texas (for ex, take another Jurisdiction Title “IN THE UNITED STATES DISTRICT COURT FOR THE WESTERN DISTRICT OF TEXAS EL PASO DIVISION”—This is a Texas—W.D. Court). Thus, the Court Type is mapped to “SUPERIOR” in the present case.

Finally, the mapped Court Name is obtained from litCourtNames Rules list. Herein, the Court Name strings likely to be encountered form the basis for creating the respective Rule. Each Rule is composed of three Sub Rules like “TEXAS (COUNTY\s*OF\s*HARRIS)|(HARRIS\s*COUNTY) Harris”, each separated by a tab. The first Sub Rule is the State Name (“TEXAS” in this case), the second is the Name-Expression(“(COUNTY\s*OF\s*HARRIS)|(HARRIS\s*COUNTY)” herein) to map the name in the Jurisdiction Header, while the third Sub Rule is the actual Court Name (“Harris” to name here) in the DB. Accordingly, Harris gets extracted here.

With the State, Court Type and Court Name, the Business Layer checks with the database values and if a match is made, then the CourtID is extracted which is what is stored in the abstract for this document. Anytime, a request/Search is made for this document, the CourtID is used to get the STATE and COURTNAME for display.

The above represents the rules for extracting State based Courts. Before this process is done, the extraction of Jurisdiction Header is done using the litJurisdictionList. This extraction has Rules to extract Federal and ADR Agencies Courts. If one of these Rules match, then the stepped Jurisdiction Rules parsing is not done and hence no State gets extracted. If no State is extracted, then Parse for the Federal Courts using the litFedCourtNames Rules. If this fails, then push these through litTribunalInfo to get Tribunal Information.

An application provides full text search support on Litigation and Deal documents, SmartRules™ and Clause Heading of Deal documents. Clause Headings will be stored as VARCHAR in a column and the documents will be stored on the FileServer.

The Indexing service provides:

1. Property search. This search is more of statistical information and more of metadata like Author, Subject type, Word count, Last written etc.

2. Full text search.

◯ Proximity search (proximity term: near)

◯ Inflectional (generation term)

◯ Weighted search (weighted term: queries that match a list of words and phrases, each optionally given its own weighting)

◯Free text

§ Simple terms: Single word or phrase

§ Prefix terms: They are extension of simple terms where they can have the form of wildcards like agree*.

§ Contains search conditions: AND, AND NOT, OR

The same feature set extends at the TSQL table level as well (i.e these predicates are available in a little different syntax if the query is performed against a database table/column instead of external files).

Every defined category may have a _Primary.txt file (e.g., Copyright_Rules_Primary.txt). Each _Primary.txt file includes at least one (or more) primary rule(s). The primary rules are expressed in the following format:

| | | | | | | | | | | |
|---|---|---|---|---|---|---|---|---|---|---|
| Weight | Proximity | Min | Primary | DistaHemang | Secondary | Rule | Substantive | Subject | SM | SM |
| | Weight | Occurs | Term | Sanghavince | Term2 | Display | Area | Matter | Weight | Threshold |

Each primary rule identifies a Primary Term (a word or phrase) that may appear in a given category within a set of documents. For example, the word “easement” may appear in certain document that should be deemed to fit in the substantive legal area of property documents.

Additionally, the engine can identify more complex concepts by locating two or three words/phrases near each other. In this case, the engine will find Primary Terms within a certain defined Distance (number of words) from SecondaryTerm1 (a word or phrase) and/or (the and/or is user defined and called the Operator) a Secondary Term2 (a word or phrase). For example, to identify the concept of breach in a contract document, a rule might identify the word “breach” (Primary Term) within 10 (Distance) words of the words “contract” (Secondary Term1) or (Operator) “agreement” (Secondary Term2).

Each primary rule is assigned a Weight value based on its distinctiveness (the more distinctive or rare, the higher the weight).

Each primary rule is assigned a MinOccurs (minimum occurrences) value based on the relative frequency of its appearance in a given document set (the more common, the higher the MinOccurs).

Each primary rule may be assigned a Rule Display, which is the exact text that will be displayed to the end-user when a given rule has been identified and the document has been categorized as falling into that substantive area. For example, to identify the concept of breach in a contract document, a rule might identify the word “breach” (Primary Term) within 10 (Distance) words of the words “contract” (Secondary Term1) or (Operator) “agreement” (Secondary Term2). Rather than display the complex primary rule, the text displayed to the end-user could be “Breach of contract.” However, a primary rule need not have a Rule Display name. For example, one might look for the word “tax” to identify documents belonging to the category of Tax Law, but showing the end-user a Rule Display of “Tax” adds little to their analysis of the document's contents.

C. Wild Cards:

In both sets of rules, the Keywords, Primary Terms, and Secondary Terms, can be include “wild cards.” Wild cards deepen the rule base by defining a Keyword, Primary Term or Secondary Term as a group of words that capture various similar expressions. A rule identifying the concept of “capacity to contract” could look for the word “capacity” within 5 words of the word “contract”. This rule would correctly identify occurrences of “capacity to contract,” but would not identify the phrase “contractual capacity.” One could create a new rule to capture every variation of the word contract; however, the SA engine allows a user to define a Keyword, Primary Term or Secondary Term as a group of words to allow one rule to identify multiple variations of the target concept. For example, a user could modify the above rule to look for the word “capacity” within 5 words of the wild card “contract!”. Placing an exclamation point at the end of a Keyword, Primary Term or Secondary Term tells the engine to lookup the wild card in the WildCards.txt file and substitute all defined terms in place of the wild card to essentially extend the rule in to X number rules (X being the number of words associated with the wild card). In the example above the wild card “contract!” might be defined as: contract, contracting, contracts, contracted, and contractual. Using this expression, the rule would correctly identify occurrences of “capacity to contract” and “contractual capacity.”

Full text searching of a conventional type may be carried out. The full text search uses an application Microsoft Technologies and supports open standards including XML, SOAP. The web server uses IIS 5.0 hosting ASP pages. The middle tier is formed of components running in the COM+ environment. The data tier uses ADO. The database server is SQL 2000 and search technologies include Indexing Service (comes as a Windows 2000 base service), Full Text Search support provided by SQL 2000.

SQL Server 2000 uses the same search engine technology used by SharePoint portal Server, benefits from same advanced ranking algorithm and uses a subset of the full-text extensions to SQL used by SharePoint Portal Server.

Full-text search SQL extension are integrated into the T-SQL language. Users can specify SQL queries that can span structured data from SQL tables, unstructured data from SQL columns, from documents embedded in the columns, and from the file system.

Other embodiments are intended to be included. For example, while the above has described software modules, it should be understood that the functions described herein could be alternatively implemented in hardware, e.g., using FPGAs or the like.

All such modifications are intended to be encompassed within the following claims.

What is claimed is:

1. A system, comprising:
a user interface which receives a request for information about a legal task, including at least a legal category, a document type, and a jurisdiction; and
an information provider, which returns information based on said legal task, document type and jurisdiction, said information including jurisdiction-specific law for said legal issue, narrative information about the jurisdiction-specific law, and links to specific sources including information about the jurisdiction-specific law, and also includes specific local information including local information about the document type for the jurisdiction.

2. A system as in claim 1, wherein said information includes a specific judge's rules for a certain task.

3. A system as in claim 1, wherein said information provider also returns procedural checklists for a specific task.

4. A system as in claim 1, wherein said information also includes court specific rules for a specific task.

5. A system as in claim 1, wherein said information provider includes document specific rules including information about a format of a document for a specific task.

6. A system, comprising:
an abstract creation element, receiving information about a plurality of documents, and determining, from each document, specific information about each document, based on the actual words within the document, and context of said words within the document, where said context includes at least the presence of at least one of a plurality of specified other words within the document, and which produces an abstract based on said specific information, in a searchable form.

7. A system as in claim 6, wherein said specific information includes a point of law discussed by the document.

8. A system as in claim 6, wherein said specific information includes a court name within the document.

9. A system as in claim 6, wherein said specific information includes a cite to a statute, and wherein said database includes information enabling determination of the full text of the statute.

10. A system as in claim 6, wherein said database is in hyperlinked format.

11. A system as in claim 10, wherein said database is in XML format.

12. A system as in claim 10, wherein said plurality of documents include documents produced by users of the system, and documents representing external information, and said specific information includes at least one cite to the external information, and produces a database which enables viewing said external information based on said cite.

13. A system as in claim 6, wherein said specific information includes first information enabling determination of a proper name of a specific category of person referenced within the document while excluding other proper names within the document, and second information enabling determination of a document category.

14. A system as in claim 13, wherein said proper name is a lawyer's name, and said specified other words within the document include at least one of “Esq” or “LLP”.

15. A system as in claim 13, wherein said proper name is a judge's name.

16. A system as in claim 13, wherein said document category represents a point of law being discussed in the document.

17. A system as in claim 13, wherein said document category represents a type of the document.

18. A computer-readable storage medium having a set of instructions for a computer having a user interface, a database, and access to a plurality of documents, the set of instructions comprising:
a first objective-extracting instruction set determining information within each document based on analysis of words in the document and a position of those words within the document to look for a specific pre-enumerated item of information from within the document;
a second subjective-extracting instruction set, determining a category for the document by searching the document; and
a third instruction set, producing a document index in a searchable form based on first and second instruction sets.

19. A medium as in claim 18, said instruction sets determine information about legal documents.

20. A medium as in claim 19, further comprising instructions which determine references to statutes within the documents, and wherein said document index includes a link to a full text of the statutes.

21. A medium as in claim 18 further comprising instructions to determine a size of the document, to compare said size of said document to a minimum size, and to prevent said first instruction set and said second instruction set from operating when said document is smaller than said minimum size.

22. A medium as in claim 18, further comprising instructions to determine specific words in the document which indicate that the document should not be indexed, and to prevent said first instruction set and said second instruction set from operating when said words are determined.

23. A medium as in claim 22, wherein said words include words indicating that the document should be discarded.

24. A medium as in claim 19, further comprising instructions to determine specified names of a certain type within the documents while excluding other names which are not of said certain type.

25. A medium as in claim 22, further comprising instructions to determine words within the document which indicate that the document is one which is intended to be discarded, and to prevent said first instruction set and said second instruction set from operating when said words are determined.

26. A medium as in claim 19, further comprising instructions to determine cites to legal statutes within the document, and to create links to full text of said legal statutes.

27. A method comprising:
using a computer to review contents of a plurality of documents;
using said computer to determine specified items of information within said documents based on context and position within the documents, while ignoring other information of the same type within the document; and
creating a searchable abstract of the documents, based on said specified items of information.

28. A method as in claim 27, wherein said specified item of information is a name of a specified kind of person, and said other information is other names within the document.

29. A method as in claim 27, wherein said specified item of information is a specified type of law.
